(19) United States
(12) Patent Application Publication
(10) Pub. No.: US 2022/0309382 A1
(43) Pub. Date: Sep. 29, 2022

(54) ANALYZING MACHINE LEARNING CURVES OF SOFTWARE ROBOTS

(71) Applicant: INTERNATIONAL BUSINESS MACHINES CORPORATION, Armonk, NY (US)

(72) Inventors: Sandeep Sukhija, Rajasthan (IN); Harish Bharti, Pune (IN); Rajesh Kumar Saxena, Maharashtra (IN); Rakesh Shinde, Maharashtra (IN)

(21) Appl. No.: 17/210,150

(22) Filed: Mar. 23, 2021

(51) Int. Cl. G06N 20/00; G06K 9/62; G06F 16/901; G06N 7/00

(52) U.S. Cl. CPC G06N 20/00; G06K 9/6256; G06K 9/6297; G06F 16/9024; G06N 7/005

(57) ABSTRACT

Systems and methods for analyzing machine learning of cognitive software robots (CogBots) over time are provided. In implementations, a method includes generating, by a computing device, a graph of historic learning curves based on historic learning data over time for a subject obtained from a primary cognitive software robot (CogBot) and at least one secondary CogBot; generating, by the computing device, a best probable learning curve based on the historic learning curves of the graph, wherein the best probable learning curve is predictive of future learning by the primary CogBot for the subject; and generating, by the computing device, information regarding a current status of the learning of the primary CogBot based on the best probable learning curve.

### BACKGROUND

Aspects of the present invention relate generally to machine learning and, more particularly, to analyzing machine learning curves of cognitive software robots (CogBots).

Machine learning is a method of data analysis that automates analytical model building, and is a branch of artificial intelligence (AI) based on the idea that computing systems can learn from data over time. Cognitive software robots or CogBots may utilize machine learning over time to improve functionality. CogBots may be sophisticated, multilingual, virtual agents (e.g., conversational AI) that use best-of-breed AI services selected from top AI vendors. The capability of these CogBots is improved by using AI technology to improve the productivity of domain experts. In general, the knowledge of such CogBots can be enhanced by adding answers, uploading documents, or integrating with existing content management systems.

### SUMMARY

In a first aspect of the invention, there is a computer-implemented method including: generating, by a computing device, a graph of historic learning curves based on historic learning data over time for a subject obtained from a primary cognitive software robot (CogBot) and at least one secondary CogBot; generating, by the computing device, a best probable learning curve based on the historic learning curves of the graph, wherein the best probable learning curve is predictive of future learning by the primary CogBot for the subject; and generating, by the computing device, information regarding a current status of the learning of the primary CogBot based on the best probable learning curve.

In another aspect of the invention, there is a computer program product including one or more computer readable storage media having program instructions collectively stored on the one or more computer readable storage media. The program instructions are executable to: obtain historic learning curve data over time for a subject from a primary cognitive software robot (CogBot); obtain historic learning curve data over time for the subject from at least one secondary CogBot; generate a graph of historic learning curves based on the historic learning data over time for the subject obtained from the primary and secondary CogBots, wherein historic learning curves of the graph represent different learning paths taken by the primary CogBot and the at least one secondary CogBot for the subject over time; and generate a best probable learning curve based on the historic learning curves of the graph, wherein the best probable learning curve is predictive of future learning by the primary CogBot for the subject.

In another aspect of the invention, there is system including a processor, a computer readable memory, one or more computer readable storage media, and program instructions collectively stored on the one or more computer readable storage media. The program instructions are executable to: obtain historic learning curve data over time for a subject from a primary cognitive software robot (CogBot); obtain historic learning curve data over time for the subject from at least one secondary CogBot; generate a graph of historic learning curves based on the historic learning data over time for the subject obtained from the primary and secondary CogBots, wherein historic learning curves of the graph represent different learning paths taken by the primary CogBot and the at least one secondary CogBot for the subject over time; generate a best probable learning curve based on the historic learning curves of the graph, wherein the best probable learning curve is predictive of future learning by the primary CogBot for the subject; obtain current learning data from the primary CogBot; and generate information regarding a current status of the learning of the primary CogBot based on the best probable learning curve and the current learning data from the primary CogBot.

### BRIEF DESCRIPTION OF THE DRAWINGS

Aspects of the present invention are described in the detailed description which follows, in reference to the noted plurality of drawings by way of non-limiting examples of exemplary embodiments of the present invention.

FIG. 1 depicts a cloud computing node according to an embodiment of the present invention.

FIG. 2 depicts a cloud computing environment according to an embodiment of the present invention.

FIG. 3 depicts abstraction model layers according to an embodiment of the present invention.

FIG. 4 shows a block diagram of an exemplary environment in accordance with aspects of the invention.

FIG. 5 shows a flowchart of an overview of an exemplary method in accordance with aspects of the invention.

FIG. 6A depicts a graph of exemplary learning curves for a subject in accordance with aspects of the invention.

FIG. 6B depicts the selection and analysis of portions of the graph of FIG. 6A in accordance with aspects of the invention.

FIG. 7 shows an exemplary method of analyzing CogBot learning curves in accordance with aspects of the invention.

FIG. 8 shows an exemplary directed acyclic graph (DAG) in accordance with aspects of the invention.

### DETAILED DESCRIPTION

Aspects of the present invention relate generally to machine learning and, more particularly, to analyzing machine learning curves of cognitive software robots (CogBots). The term CogBot as used herein refers to a cognitive software robot (i.e., a software agent designed to automate tasks) with machine learning capabilities to continuously learn on a topic and make suggestions to users in response to inquiries based on the learning. In embodiments, a method or framework is provided to identify a best learning path for a primary CogBot by analyzing a current learning path of the primary CogBot, then predicting the closest learning path in the future based on other CogBot's (secondary CogBot's) learning curves and the primary CogBot's own learning curve on the same subject or topic. In implementations, a predictive model is based on measuring a distance of reference learning curve's from different points at a particular time, then creating a best probable learning curve (look ahead learning curve) for the primary CogBot. In embodiments, predictive or look-ahead learning curves created from known learning curves become a benchmark to analyze if a learning curve of an existing CogBot is going in a positive direction.

Existing CogBots each have their own capability and learning paths. Accordingly, it may be desirable to evaluate their knowledge or learning capability so that the CogBots can act and react appropriately in real-world situations. Since CogBots keep getting smarter through iterative teaching, it is beneficial to evaluate a CogBots learning capability by comparing it with other CogBots' learning curves, as well as its own prior learning curve on the same subject or topic. Embodiments of the invention address the technical problem of determining a maturity level of a CogBot's learning process by analyzing current and historic learning curves for a particular topic or domain.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium or media, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

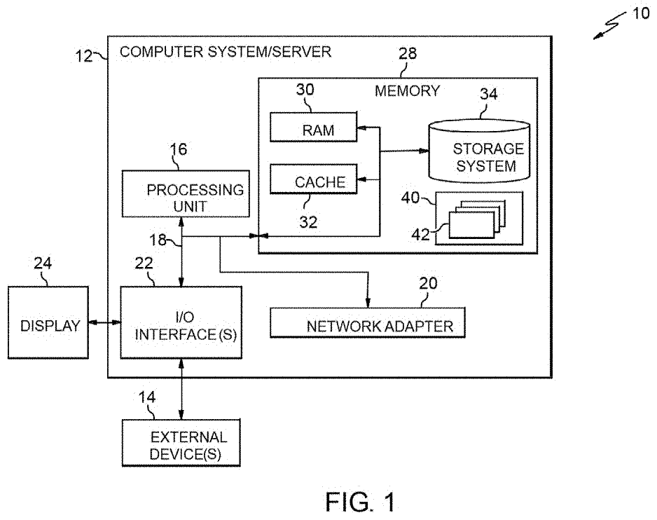

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

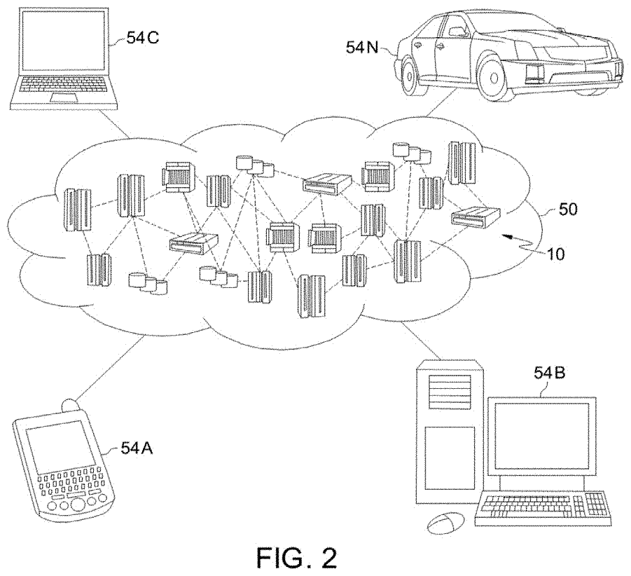

Referring now to FIG. 2, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

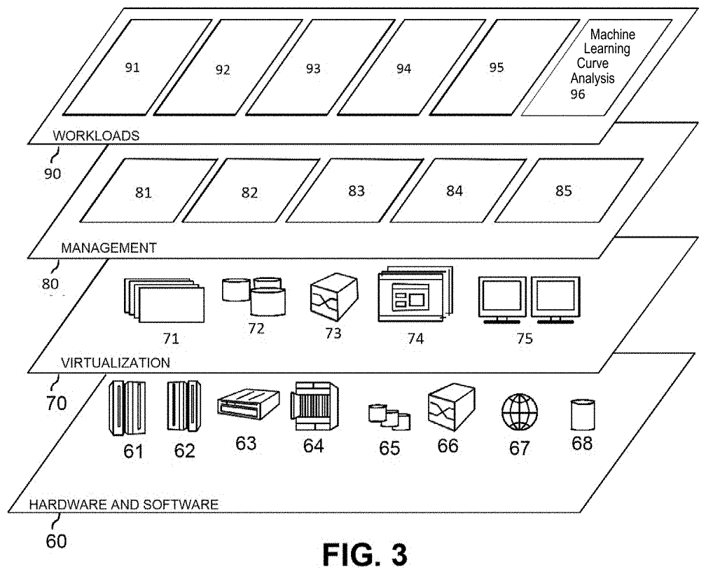

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and machine learning curve analysis 96.

Implementations of the invention may include a computer system/server 12 of FIG. 1 in which one or more of the program modules 42 are configured to perform (or cause the computer system/server 12 to perform) one of more functions of the machine learning curve analysis 96 of FIG. 3. For example, the one or more of the program modules 42 may be configured to: obtain current and historic learning curve data from primary and secondary CogBots; generate a graph of historic learning curves over time for a subject; identify an initial set of beeps in the graph; select a subset of beeps based on a global constraint; generate a best probable learning curve for the primary CogBot based on the subset of beeps; iteratively update the best probable learning curve over time to generate updated best probable learning curves; generate information regarding the status of learning of the primary CogBot; generate a directed acyclic graph (DAG) based on the updated best probable learning curves; and generate information regarding a learning maturity status of the primary CogBot based on the DAG.

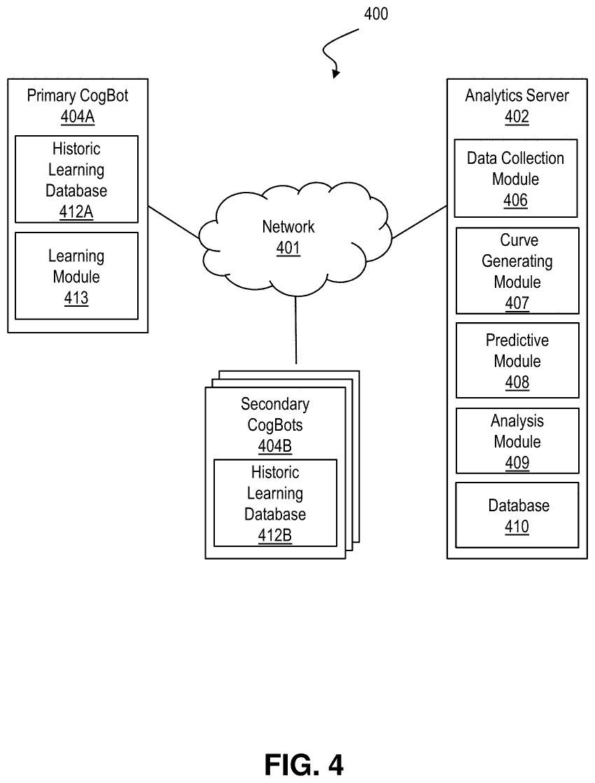

FIG. 4 shows a block diagram of an exemplary environment 400 in accordance with aspects of the invention. In embodiments, the environment 400 includes a network 401 interconnecting an analytics server 402 with a primary CogBot 404A and one or more secondary CogBots 404B. The term primary CogBot as used herein refers to a CogBot for a particular domain or topic whose machine learning curve or learning maturity is being analyzed in accordance with embodiments of the invention. The term secondary CogBot as used herein refers to other CogBots relevant to the same domain or topic as the primary CogBot. In one example, the primary and secondary CogBots comprise virtual agents (e.g., conversational artificial intelligence) in the field (domain) of banking.

The network 401 may be any suitable communication network or combination of networks, such as a local area network (LAN), a general wide area network (WAN), and/or a public network (e.g., the Internet). In embodiments, the analytics server 402, the primary CogBot 404A and the one or more secondary CogBots 404B, comprise nodes 10 in the cloud computing environment 50 of FIG. 2. In implementations, the analytics server 402 provides cloud-based services to one or more clients (e.g., via a client's desktop computer 54B) in the environment 400 via the network 401.

In implementations, the analytics server 402 includes one or more components of the computer system 12 of FIG. 1 and is configured to obtain data from one or more data sources (e.g., CogBots 404A, 404B). In embodiments, the analytics server 402 is a special purpose computing device providing data analytics for clients of the network 401. The analytics server 402 may include one or more program modules (e.g., program module 42 of FIG. 1) executed by the analytics server 402 and configured to perform one or more functions described herein.

In embodiments, analytics server 402 includes one or more of the following program modules (e.g., program modules 42 of FIG. 1): a data collection module 406, a curve generating module 407, a predictive module 408, an analysis module 409 and a database 410. In implementations, the data collection module 406 is configured to obtain historic learning curve data from a historic learning database 412A of the primary CogBot 404A and one or more historic learning databases 412B of one or more secondary CogBots 404B. In implementations, the data collection module 406 is also configured to obtain current learning curve data (e.g., from a learning module 413) of the primary CogBot 404A. The term learning curve data as used herein refers to data regarding changes to machine learning over time.

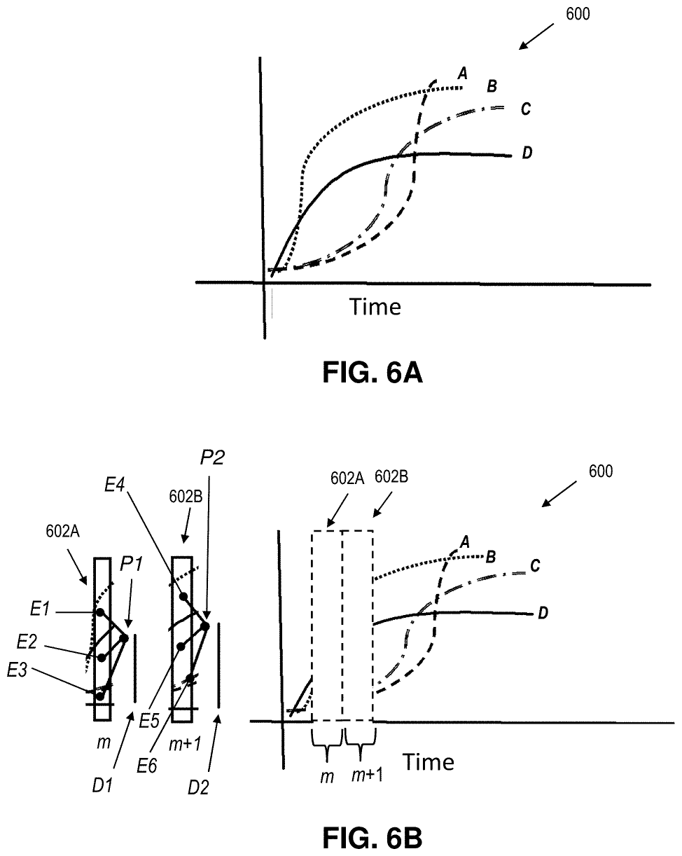

In embodiments, the curve generating module 407 is configured to generate a graph of learning curves for a domain (targeted subject area), based on historic learning curve data obtained from the primary CogBot 404A and one or more secondary CogBots 404B. The term learning curve as used herein refers to plots that show changes in learning performance over time. In one example, a learning curve is graphed as a line plot of learning (y-axis) over experience or time (x-axis). An example of such a graph 600 is depicted in FIG. 6A.

In implementations, the predictive module 408 is configured to analyze the graph of learning curves generated by the curve generating module 409, and generates a best probable learning curve. The best probable learning curve provides a benchmark for the analytic server 402 to analyze if the primary CogBot 404A is learning as expected/predicted.

In aspects of the invention, the analysis module 409 is configured to compare a current learning curve of the primary CogBot 404A with the best probable learning curve to determine a maturity level of the primary CogBot 404A. The term maturity level as used herein refers to a level of learning the primary CogBot has attained at a given time. In implementations, the analysis module 409 determines a maturity of the primary CogBot 404A based on a gradient of a directed acyclic graph (DAG) generated in accordance with embodiments of the invention. The term gradient as used herein refers to a measure of the change in all weights with regard to a change in error. In one example, the gradient can be a slope of a function, wherein the higher the gradient, the steeper the slope and the faster a model can learn. In aspects, the analysis module 409 recalibrates the primary CogBot 404A to generate an updated primary CogBot 404A based on information from one or more secondary CogBots.

In implementations of the invention, historic learning curve data, current learning curve data, graphs of learning curves and predictive curve data may be saved in one or more databases of the analytics server 402, such as the database 410.

In embodiments, the primary CogBot 404A and one or more secondary CogBots 404B each comprise software implemented on one or more computing devices, wherein the computing devices include one or more components of the computer system 12 of FIG. 1. Each of the primary and secondary CogBots 404A and 404B are configured to perform automated tasks related to at least one domain (targeted subject area). In embodiments, the primary CogBot 404A includes the historic learning database 412A configured to save data related to machine learning over time, and a learning module 413 configured to provide current machine learning data for a particular time to the analytics server 402 for analysis. Likewise, the one or more secondary CogBots 404B may each include respective historic learning database 412B configured to save data related to machine learning over time.

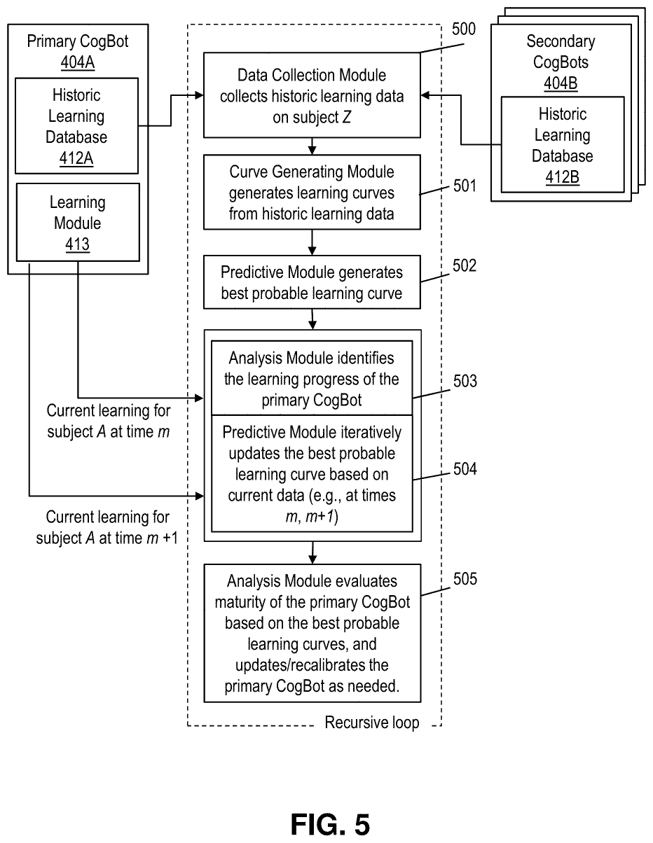

FIG. 5 shows a flowchart of an overview of an exemplary method in accordance with aspects of the present invention. Steps of the method may be carried out in the environment 400 of FIG. 4 and are described with reference to elements depicted in FIG. 4.

At step 500, the analytics server 402 collects historic learning data (e.g., machine learning data) from the primary CogBot 404A (e.g., from historic learning database 412A) for a particular topic or subject matter Z. Optionally, the analytics server 402 also collects historic learning data (e.g., machine learning data) from one or more of the secondary CogBots 404B (e.g., from respective historic learning databases 412B) relevant to the same subject matter Z. In one example, both the primary CogBot 404A and the one or more secondary CogBots 404B are concerned with automating tasks in the domain of banking. In aspects, the data collection module 406 of the analytics server 402 implements step 500.

At step 501, the analytics server 402 generates a graph of learning curves based on the historic learning data obtained at step 500. In implementations, the curve generating module 407 implements step 502. In embodiments, the learning curves generated by the analytics server 402 represent learning paths that have been taken in the past successfully by the primary CogBot 404A and/or the secondary CogBots 404B for the subject matter Z.

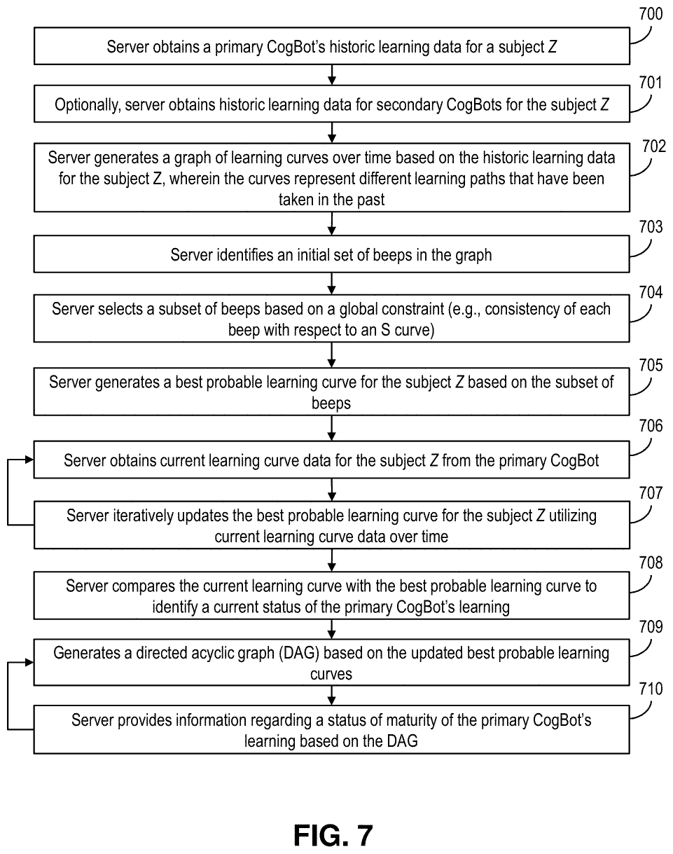

At step 502, the analytics server 402 generates a best probable learning curve based on the graph of step 501. In implementations, the predictive module 408 implements step 502. In aspects, the analytics server 402 creates different points (beeps) at different periods of time and then compares the distance with beeps of the referenced curve and point considered at that time. The least distance point shows the best probable curve for the primary CogBot 404A. The analytics server 402 may then compare the best probable learning curve with the actual learning of the CogBot 404A at a current time to extract how the learning on the subject by the primary CogBot 404A matches with the best probable learning curve. Additional details regarding the generation of the best probable learning curve are discussed below with respect to FIG. 7.

At step 503, the analytics server 402 compares current learning data from the primary CogBot 404A with the best probable learning curve (look ahead curve) to determine progress of primary CogBot's learning. In implementations, the analytics server 402 generates and displays graphical and/or text information to user via a graphical user interface (GUI) to provide the user with information regarding a current learning status of the primary CogBot 404A with respect to the predictive best probable learning curve. In embodiments, the analytics server 402 initiates an evaluation process of step 503 at different time intervals, such that the analytics server 402 periodically evaluates whether the primary CogBot 404A is maturing on the subject (e.g. subject Z) with respect to a best probable learning curve. In implementations, the analysis module 409 of the analytics server 402 implements step 503.

At step 504, the analytics server 402 iteratively updates the best probable learning curve based on current learning data from the primary CogBot 404A. In implementations, the actual learning path (current learning data) of the primary CogBot 404A is sent to the analytics server 402 as output data, and utilized by the analytics server 402 for the next iteration of the best probable learning curve. In implementations, the predictive module 408 of the analytics server 402 implements step 504. Additional details regarding the process of iteratively updated the best probable learning curve are discussed below with respect to FIG. 7.

At step 505, the analytics server 402 evaluates the maturity of the primary CogBot 404A based on the best probable learning curves derived over time, and recalibrates the primary CogBot 404A as needed. In embodiments, a level of maturity is determined by the analytics server 402 based on a gradient of a DAG generated in accordance with embodiments of the invention. Additional details regarding the generation of the DAG are discussed below with respect to FIG. 7. In implementations, the analysis module 409 of the analytics server 402 implements step 505.

In implementations, once the maturity of a primary CogBot's learning curve is known, the primary CogBot 404A can be trained to improve the learning gradient of the primary CogBot 404A. Changes to the learning curve of a CogBot can be fed to the network 401 for community use. For example, CogBots can learn from other CogBots which are designed for: (1) Specificity (i.e., employing a CogBot to work on very clear field of use cases); (2) Specialization (i.e., employing the knowledge for anonymized test data that can be leveraged for relative topics); (3) Learning Gradient (i.e., the learning gradient can work as a hyper parameter that fine tunes machine learning of other CogBots); (4) Implied hyper parameterization (i.e., for specific use of the tuning methodology in gradient descent, back propagation and other deep learning framework driven CogBots. In embodiments, a recalibrated/updated primary CogBot 404A is provided to a client for whom the primary CogBot 404A was updated, or is made available to users to answer user inquiries for a domain or topic.

FIG. 6A depicts a graph 600 of exemplary learning curves A-D in accordance with aspects of the invention. The graph of FIG. 6A may be generated in the environment 400 of FIG. 4. The exemplary graph 600 is generated based on historic learning curve data from the primary CogBot 404A and secondary CogBots 404B, and includes four distinct learning curves A-D. Each of the learning curves A-D represent a distinct pathways of learning that was taken for the same subject matter Z by different CogBots 404A, 404B over time.

FIG. 6B depicts the selection and analysis of portions of the graph 600 of FIG. 6A in accordance with aspects of the invention. More specifically, FIG. 6B depicts beeps E1-E6 identified from portions 602A and 602B of graph 600 taken at respective measurement times periods m and m+1. The term beep as used herein refers to a homogeneous dimension which is a locus of all intersecting points of the graphed curves (curve family). For each time period, beeps E1-E6 are selected/identified at a least distance point between two curves on the graph 600. For example, beep E1 is at the least distance point between curves B and D at time m. Utilizing Kalman filtering, the analytics server 402 predicts probable points P1 and P2 of a best probable learning curve (look ahead curve) for the topic Z based on the beeps E1-E6, wherein each of the probable points P1 and P2 are at a respective distance D1 and D2 from the horizontal axis of the graph 600. Additional details regarding the identification of beeps and generation of a probability learning curve are discussed below with respect to FIG. 7.

FIG. 7 shows an exemplary method of analyzing CogBot learning curves in accordance with aspects of the invention. Steps of the method may be carried out in the environment 400 of FIG. 4, are described with reference to elements depicted in FIG. 4, and are performed consistent with the method overview of FIG. 5. The steps of FIG. 7 provide a model for combining historic learning curves to understand the maturity of the primary CogBot's maturity (as a gradient).

At step 700, the analytics server 402 obtains a primary CogBot's historic learning data for a subject (e.g., subject Z). In one example, the data collection module 406 of the analytics server 402 obtains historic machine learning data from the historic learning database 412A of the primary CogBot 404A, in accordance with step 500 of FIG. 5.

At step 701, the analytics server 402 optionally obtains historic learning data from one or more secondary CogBot's relevant to the same subject (e.g., subject Z). It should be understood that subject Z referenced herein can be any domain/subject, such as automotive, healthcare, finance, real estate, etc. In one example, the data collection module 406 of the analytics server 402 obtains historic machine learning data from the historic learning databases 412B of one or more secondary CogBots 404B, in accordance with step 500 of FIG. 5. The secondary CogBots 404B may be trusted CogBots in the same domain (e.g., subject Z) as the primary CogBot 404A, or in a domain relevant to the domain of the primary CogBot 404A.

At step 702, the analytics sever 402 generates a graph of learning curves over time based on the historic learning data from steps 700 and step 701. Graph 600 of FIG. 6A represents an exemplary graph generated at step 702 in accordance with embodiments of the invention. Each of the learning curves (e.g., A-D in FIG. 6A) represent different learning paths that have been taken by the CogBots 404A and 404B over time.

Error Estimation

At step 703, the analytics server 402 identifies an initial set of beeps (e.g., beeps E1-E6 of FIG. 6B) for the graph of step 702 (e.g., graph 600). As noted previously, the term beep as used herein refers to a homogeneous dimension which is a locus of all intersecting points of the graphed curves (curve family). In aspects, the analytics server 402 generates a best probable learning curve from points that can intersect with each of the graphed curves (e.g., A-D of FIG. 6), where these intersects are known as beeps or possibilities. In implementations, beeps are generated for multiple time periods (e.g., m, m+1 of FIG. 6) along the graph.

At step 704, the analytics server 402 selects a subset of beeps based on consistency of each beep with respect to a geometric aspects of a particular curve. In implementations the analytics server 402 selects a subset of beeps from the initial set of beeps identified at step 703, based on geometric aspects of a particular curve by defining a fitting error e^{fit} of a set of beeps, {E₀ . . . Eₘ}, as the sum of the Least-Squared distances between the beeps and the best fitting shape s in S, utilizing the following first equation Eq(1) (Estimator).

$${e}^{fit} ( {E}_{0} .. {E}_{m} ) = {min}_{s ∈ S} {\sum }_{i = 0}^{m} {d}^{2} ( {E}_{i} , s ) . \qquad Eq ( 1 )$$

In embodiments, the analytics server 402 determines if the fitting error e^{fit}(E₀ . . . Eₘ) is greater or equal to a predetermined error size. An error larger than the predetermined error size indicates that the beep set cannot be well represented by a curve in S, which means that adding a beep to the set of beeps (E₀ . . . Eₘ) will increase the fitting error e^{fit}. If the fitting error e^{fit}(E₀ . . . Eₘ) is greater than the predetermined error size, a measure eₒᵥₑᵣ({E₀, . . . Eₘ}) is introduced based on a sum of the beep lengths and based on the beeps density within the fitted curve, utilizing the following second equation Eq(2).

e^{over}(E₀ . . . Eₘ₊₁)≥eₒᵥₑᵣ(E₀ . . . Eₘ)+e^{fit}(Eₘ₊₁). Eq(2)

An “energy” (G), that indicates how consistent the beeps are with respect to the best curve in S, is defined by the weighted differences of e^{over} and e^{fit}, utilizing the following third equation Eq(3), where λ controls the tradeoff between e^{fit} and e^{over}.

G(E₀ . . . Eₘ)=λe^{over}(E₀ . . . Eₘ)−e^{fit}(Eₘ₋₁). Eq(3)

The energy gain (γ) of grouping a particular beep Eₘ₊₁ with a set of beeps {E₀ . . . Eₘ} is then derived by the following fourth equation Eq(4).

γ=G(E₀, . . . , Eₘ,Eₘ₊₁)−G(E₀ . . . Eₘ)−G(Eₘ₊₁). Eq(4)

A positive γ represents a likely good grouping of beeps. A set of beeps having a large G is determined to be an important geometrical structure by the analytics server 402. In implementations, the analytics server 402 keeps only subsets of the beep set (select beeps from the initial beep set) that have a large enough G (greater or equal to a predetermined number), which constitutes a valid alternative over selecting beeps with respect to their contrast amplitudes.

The solution (selected subset of beeps) is the subsets of Eq(4) which can be found utilizing the following fifth equation:

E(p)=Σ_{p∈P}(λe^{over}({Eᵢ}∈P)−e^{fit}({Eᵢ}∈P)). Eq(5)

In implementations, the analytics server 402 obtains an approximate solution of Eq(1) in a reasonable time under the following assumptions: (1) connected straight line beeps can be grouped together (thus, beeps can be defined as straight line segments); (2) the family of the shapes S is a linearly parameterizable subset of curves; and (3) the beep set can be ordered (therefore, the beep graph is a connected acyclic directed graph).

Curve Augmentation

At 705, the analytics server 402 generates a best probable learning curve for the subject Z based on the selected subset of beeps using a fitting algorithm. In implementations, the analytics server 402 utilizes Kalman filtering to generate the best probable learning curve. A Kalman filter (also known as a linear quadratic estimation (LQE)), is an efficient recursive filter (algorithm) that estimates an internal state of a linear dynamic system from a series of noisy measurements. Given that the energy (G) per beep has been derived utilizing the fourth equation Eq(4), a best probable learning curve may be created over some known estimated time m, that traces a path of maximum energy (minimum noise), resulting in a path which is the closest to all curves in the set of graphed curves. The linear subspaces of the curves allow recursive estimates of the curve parameters when a new beep is provided. A beep may be described by two pixel positions, i.e., by two points on the graph of curves (e.g., graph 600 of FIG. 6).

Assuming that the dataset at issue comprises points only, the simplest way to fit a curve to the data is to minimize distance over the set of given data points. From the first equation Eq(1) we get the following sixth equation Eq(6).

eₘ^{fit}=Σ_{1≤j≤m}(F(yⱼ)^{t}Aₘ−xⱼ)². Eq(6)

The minimization of the previous fitting error gives the following seventh equation Eq(7), where, Xₘ=(xₘ)_{1≤j≤m}, shows the X coordinate of the vector, M=(F(yᵢ))_{1≤j≤m}, is the design matrix, and Sₘ=MM^{t} is the scatter matrix.

MM^{t}Aₘ=MXₘ. Eq(7)

If, Gₘ=MXₘ, we can write Eq(7) as the following eighth equation Eq(8):

SₘAₘ=Gₘ. Eq(8)

Fitting this in a Kalman filtering framework, results in the following ninth equation Eq(9), where,

$$ψ = \frac{1}{( 1 + {F}^{T} {S}^{- 1} F )}$$

defines the Kalman Covariance gradient.

$$\frac{1}{{( S + {FF}^{t} )}^{n}} = \frac{1}{A} - \frac{ψ}{sS} {FF}^{t} . \qquad Eq ( 9 )$$

The matrices can be inverted. The formulation allows for a recursive deduction.

In implementations, a best probable learning curve is created/generated by the analytics server 402 using the following tenth equation Eq(10):

Aₘ₊₁=Aₘ+Kₘ₊₁Fₘ₊₁(xₘ₊₁−Aₘ^{t}Fₘ₊₁). Eq(10)

Recursive Fitting Modulator

At step 706, analytics server 402 obtains current learning curve data for the subject Z from the primary CogBot 404A.

At step 707, the analytics server 402 updates the best probable learning curve for the subject Z utilizing the current learning curve data. In implementations, in order to determine if the primary CogBot 404A is on the best learning pathway, the analytics server 402 utilizes a back and forth mechanism (recursive being called mathematically) to trace the learning pathway of the primary CogBot 404A over time to determine if the primary CogBot 404A is on the best known pathway. This determination occurs through many iterations, and with each iteration, the analytics server 402 can update the fitment error. In implementations, the following recursive fitting algorithm is utilized: (1) the analytics server 402 selects a beep and initializes a recursive fitting by setting K₀ to k times the identity matrix, and A₀ to zero; (2) then the analytics server 402 computes the covariance matrix K₁ using Eq(9) and the curve parameters A₁ using Eq(10); and (3) given a new data point (xₘ₊₁, yₘ₊₁), the covariance matrix Kₘ is updated using Eq(9) and the curve parameter vector Aₘ is updated using Eq(10).

In implementations, at step 708, the analytics server 402 provides a current status of the primary CogBot 404A to a user based on the best probable learning curve. In implementations, the analytics server compares the current learning curve data obtained at step 706 to the best probable learning curve to identify the progress (current status) of learning of the primary CogBot 404A based on deviations of the learning curve data from the best probable learning curve. Information derived by the analytics server 402 with respect to a current learning status of the primary CogBot 404A may be presented to a user by the analytics server 402 via a GUI, or by otherwise sending the information to a user via the network 401.

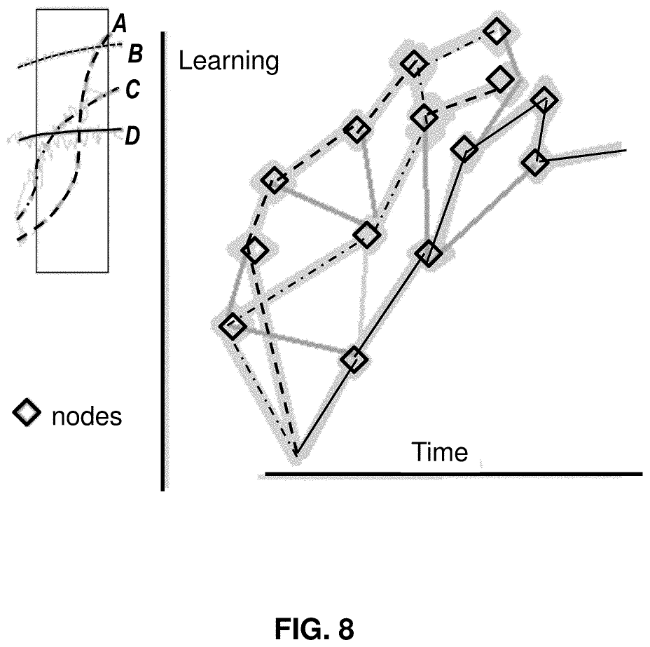

At step 709, the analytics server 402 generates a directed acyclic graph (DAG) based on the updated best probable learning curves obtained over time by the iterative updating discussed in step 707. See the exemplary DAG of FIG. 8, for example. In embodiments, the analytics server 402 stacks beeps as a directed graph as follows. Starting from the bottom of a curve (e.g., A-D of FIG. 6), that curve is always grown upward towards a smaller y. The analytics server 402 organizes the beeps as nodes in a DAG, where every beep is linked to all other consistent beeps with smaller y coordinates. Thus it can be understood that changes in the known data of secondary CogBots 404B (their learning ability being reflected in the learning gradient for a given topic), will enable the analytics server 402 to recalibrate the learning curve (DAG) for the primary CogBot 404A to generate an updated primary CogBot 404A. In implementations, the updated CogBot 404A is provided to client via the network 401 to be implemented at another location on the network 401, wherein the updated CogBot 404A is utilized to answer questions regarding the subject Z in response to received user inquiries. In embodiments, the updated CogBot 404A is initiated at the analytics server 402, and provides answers to questions regarding the subject Z in response to received user inquiries. For example, the updated CogBot 404A may receive an inquiry regarding banking, and may provide an answer to the inquiry via the network 401.

The result of the above is that all the traces of the beeps are now stacked as a directed graph (because they have been iteratively recursed). These traces are acyclic—else they would have gone in a loop (circle). Accordingly, the analytics server 402 creates a directed acyclic graph (DAG) of beeps that is an open system of maximum energy from the learning curves. The DAG maximizes the area under the beeps, and thus provides the best way to determine the learning gradient of the primary CogBot's maturity.

At step 710, the analytics server 402 provides information to a user regarding a status or level of maturity of the primary CogBot's learning based on the DAG generated at step 709. In implementations, each curve that is created by the primary CogBot 404A has a linearity that is referenced through its covariance matrix (a way to check that each beep [vertex] within the curve [DAG] is being represented as the energy movement from its previous point). This gradient of the DAG allows the analytics server 402 to determine/assess a maturity level or status of the primary CogBot's learning. This is referenced in Eq(11) as follows.

Let E1 and E2 be two beeps, we say that E1→E2 if there is a direct link in the graph, from E1 to E2. The analytics server 402 associates to each beep E: (1) its coordinates, and (2) the best curves arriving at E. Each curve is specified by its energy (i.e., G), its parameters A, its covariance matrix K, and its length L. In implementations, the fitting error is recursively updated, without requiring the updated curve parameters Aₘ₊₁ and the updated covariance parameters Kₘ₊₁, using the following eleventh equation Eq(11).

$${e}_{m + 1}^{fit} = {e}_{m}^{fit} + \frac{{( {x}_{m + 1} - {A}_{m}^{t} F ( {y}_{m + 1} ) )}^{2}}{1 + {F}^{t} ( {y}_{m + 1} ) {K}_{m} F ( {y}_{m + 1} )} . \qquad Eq ( 11 )$$

Based on the above, it can be understood that embodiments of the invention create look ahead curves or best probable learning curves from known prominent learning curves where a family of prominent learning curves (learning patterns of CogBot's) is used to analyze the maturity of a learning CogBot (maturity gradient). In embodiments, the analytics server 402 creates a homogeneous dimension called beeps at a locus of all intersecting points of the prominent curve family. In implementations, the analytics server 402 selecting beeps such that the analytics server 402 finds the best way to maximize the area under the curve of the next best probability. In aspects, the analytics server 402 selects beeps based on geometrical aspects, specifically corresponding to a shape approximate.

In embodiments, the analytics server 402 finds an error estimator in curve fitment and imagines that each curve has some level of energy in it that needs to be aggregate. In implementations, the analytics server 402 adds the energies, and if the energies are positive, groups the energies in a cohesive manner (or these curves are getting scattered). In aspects, the analytics server 402 uses Kalman filtering for considering the energy per beep and creating a look ahead curve such that the look ahead curve traces the path of maximum energy (minimum noise), which is closest to all learning paths using minimum noise. In embodiments, the analytics server 402 utilizes a recursive fitting modulator, where the modulator is iteratively traced over time to find best known learning pathways (which may be utilized in updating the fitment error in each iteration).

In implementations, the analytics server 402 treats a Global Gradient as maturity where the traces of the beeps are stacked as a directed graph. These are acyclic since these are iteratively recursed with the modulator. This helps in considering an acyclic graph of beeps as an open system to maximize the energy from curves. The global gradient represents the maturity of the receiving (learning) CogBot.

FIG. 8 shows an exemplary directed acyclic graph (DAG) in accordance with aspects of the invention. The DAG of FIG. 8 may be generated in accordance with the method of FIG. 7 and in the environment of FIG. 4.

The manner in which the analytics server 402 recalibrates the primary CogBot 404A will now be discussed in more detail, with reference to FIGS. 6A, 6B, 7 and 8. In implementations, the analytics server 402 can determine when there is a change in topical data (e.g., data regarding topic Z) at one or more secondary CogBots 404B. The analytics server 402 may be configured to automatically receive information or a notification regarding the change in topical data at one or more secondary CogBots 404B via the network 401 in accordance with step 500 of FIG. 5 and 701 of FIG. 7, for example.

When there is a change in topical data, which may be contributed by any of the secondary CogBots 404B there is more known information about the topical data (e.g., topic Z data), and that change in data may be relevant to the primary CogBot 404A. In implementations, the analytics server 402 determines that there is a change in topical data when there is a prominent change in the family of learning curves (e.g., learning curves A-D of FIGS. 6A and 6B), which changes the e^{fit} in the first equation Eq(1). A large error indicates that the beep set cannot be well represented by a curve in S, which means that adding a beep to a set of beeps will increase the fitting error, hence there is a measure of e^{over} in the second equation Eq(2). This means that the model of FIG. 7 is sensitive to the change in topical data (data changes) from the one or more secondary CogBots 404B, and the analytics server 402 will re-run the equations of FIG. 7 and adjust the γ of the fourth equation Eq(4). It is at this stage that the analytics server 402 has fully sensitized the primary CogBot 404A over the changes (e^{fit},e^{over}).

In a next stage, the analytics server 402 determines if the changes to the topical data are significant (meet a threshold), indicated a need for recalibration of the primary CogBot 404A. Note that, if the e^{over} of the second equation Eq(2) does not show a conspicuous change with the changing of the topical data, the e^{over} of the second equation Eq(2) will not make a considerable change to the previously fitted curve, which is taken into account in the fourth equation Eq(4). On the other hand, if the fourth equation Eq(4) indicates to the analytics server 402 that recalibration of the primary CogBot 404A is required, the analytics server 402 finds a new curve that adapts the learning curve. This is achieved through the curve augmentation using the sixth equation Eq(6) through the tenth equation Eq(10) set forth above. It can be understood that the tenth equation Eq(10) derives an updated look-ahead curve.

The output of the curve augmentation of equations 6-10 provides the analytics server 402 with a set of notable points (that have been selected across the family of curves). The analytics server 402 organizes these notable points into a look ahead curve that is cohesive in its geometry to the other learning curves, thereby adapting the learning curve to the primary CogBot 404A. This is obtained by the analytics server 402 utilizing a recursive fitting algorithm, wherein the output of the algorithm (working on the set of selected beeps from the tenth equation Eq(10) is as follows: (1) Starting from a bottom of a curve, that curve is always grown upward toward a smaller y. (2) The analytics server 402 organizes the beeps as nodes in an acyclic directional graph (DAG), where each beep is linked to all other consistent beeps with smaller y coordinates. (3) Let E1 and E2 be two beeps, we say that E1→E2 is there is a direct link in the graph, from E1 to E2. (4) The analytics server 402 associates to each beep E: its coordinates, and the best curves arriving at E. (5) Each curve is specified by its energy (i.e., G), its parameters A, its covariance matrix K, and its length L. The above-identified back propagation is achieved in the eleventh equation Eq(11), which enables the analytics server 402 to recalibrate the learning curve of the primary CogBot 404A as a new DAG, thereby generating an updated primary CogBot 404A.

In embodiments, a service provider could offer to perform the processes described herein. In this case, the service provider can create, maintain, deploy, support, etc., the computer infrastructure that performs the process steps of the invention for one or more customers. These customers may be, for example, any business that uses technology. In return, the service provider can receive payment from the customer(s) under a subscription and/or fee agreement and/or the service provider can receive payment from the sale of advertising content to one or more third parties.

In still additional embodiments, the invention provides a computer-implemented method, via a network. In this case, a computer infrastructure, such as computer system/server 12 (FIG. 1), can be provided and one or more systems for performing the processes of the invention can be obtained (e.g., created, purchased, used, modified, etc.) and deployed to the computer infrastructure. To this extent, the deployment of a system can comprise one or more of: (1) installing program code on a computing device, such as computer system/server 12 (as shown in FIG. 1), from a computer-readable medium; (2) adding one or more computing devices to the computer infrastructure; and (3) incorporating and/or modifying one or more existing systems of the computer infrastructure to enable the computer infrastructure to perform the processes of the invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, comprising:
generating, by a computing device, a graph of historic learning curves based on historic learning data over time for a subject obtained from a primary cognitive software robot (CogBot) and at least one secondary CogBot;
generating, by the computing device, a best probable learning curve based on the historic learning curves of the graph, wherein the best probable learning curve is predictive of future learning by the primary CogBot for the subject; and
generating, by the computing device, information regarding a current status of the learning of the primary CogBot based on the best probable learning curve.

2. The method of claim 1, wherein the computing device utilizes a linear quadratic estimation (LQE) to generate the best probable learning curve.

3. The method of claim 1, further comprising:
obtaining, by the computing device, the historic learning data from the primary CogBot and the at least one secondary CogBot; and
obtaining, by the computing device, current learning data from the primary CogBot, wherein the current status of the learning of the primary CogBot is based on comparing the current learning data form the primary CogBot with the best probable learning curve.

4. The method of claim 1, wherein generating the best probable learning curve comprises:
identifying, by the computing device, an initial set of beeps in the graph, wherein each beep comprises a homogeneous dimension which is a locus of all intersecting points of the historic learning curves; and
selecting, by the computing device, a subset of the initial set of beeps by imposing a global constraint, wherein the best probable learning curve is generated based on the subset of the initial set of beeps.

5. The method of claim 1, further comprising:
obtaining, by the computing device, current learning data from the primary CogBot;
updating, by the computing device, the best probable learning curve based on the current learning data to generated an updated best probable learning curve; and
repeating, by the computing device, the obtaining the current learning data from the primary CogBot and updating the best probable learning curve, iteratively, to generate a plurality of updated best probable learning curves over time.

6. The method of claim 5, further comprising:
recalibrating, by the computing device, the primary CogBot by generating a directed acyclic graph (DAG) based on the plurality of updated best probable learning curves over time, thereby producing a recalibrated primary CogBot; and
providing, by the computing device, the recalibrated primary CogBot to one or more users via a network to answer inquiries regarding the subject.

7. The method of claim 6, further comprising providing, by the computing device, information regarding a status of maturity of the primary CogBot's learning based on a gradient of the DAG.

8. The method of claim 1, wherein the computing device includes software provided as a service in a cloud environment.

9. A computer program product comprising one or more computer readable storage media having program instructions collectively stored on the one or more computer readable storage media, the program instructions executable to:
obtain historic learning curve data over time for a subject from a primary cognitive software robot (CogBot);
obtain historic learning curve data over time for the subject from at least one secondary CogBot;
generate a graph of historic learning curves based on the historic learning data over time for the subject obtained from the primary and secondary CogBots, wherein historic learning curves of the graph represent different learning paths taken by the primary CogBot and the at least one secondary CogBot for the subject over time; and
generate a best probable learning curve based on the historic learning curves of the graph, wherein the best probable learning curve is predictive of future learning by the primary CogBot for the subject.

10. The computer program product of claim 9, wherein the program instructions are further executable to utilize Kalman filtering to generate the best probable learning curve.

11. The computer program product of claim 9, wherein the program instructions are further executable to:
obtain current learning data from the primary CogBot; and
generate information regarding a current status of the learning of the primary CogBot based on comparing the current learning data from the primary CogBot with the best probable learning curve.

12. The computer program product of claim 9, wherein generating the best probable learning curve comprises:
identifying an initial set of beeps in the graph, wherein each beep comprises a homogeneous dimension which is a locus of all intersecting points of the historic learning curves; and
selecting a subset of the initial set of beeps by imposing a global constraint, wherein the best probable learning curve is generated based on the subset of the initial set of beeps.

13. The computer program product of claim 9, wherein the program instructions are further executable to:
obtain current learning data from the primary CogBot;
update the best probable learning curve based on the current learning data to generated an updated best probable learning curve; and
repeat the obtaining the current learning data from the primary CogBot and the updating the best probable learning curve, iteratively, to generate a plurality of updated best probable learning curves over time.

14. The computer program product of claim 13, wherein the program instructions are further executable to:
recalibrate the primary CogBot by generating a directed acyclic graph (DAG) based on the plurality of updated best probable learning curves over time, thereby producing a recalibrated primary CogBot; and
deploy the recalibrated primary CogBot via a network to answer questions of the one or more users regarding the subject.

15. The computer program product of claim 14, wherein the program instructions are further executable to provide information regarding a status of maturity of the primary CogBot's learning based on a gradient of the DAG.

16. A system comprising:
a processor, a computer readable memory, one or more computer readable storage media, and program instructions collectively stored on the one or more computer readable storage media, the program instructions executable to:
obtain historic learning curve data over time for a subject from a primary cognitive software robot (CogBot);
obtain historic learning curve data over time for the subject from at least one secondary CogBot;
generate a graph of historic learning curves based on the historic learning data over time for the subject obtained from the primary and secondary CogBots, wherein historic learning curves of the graph represent different learning paths taken by the primary CogBot and the at least one secondary CogBot for the subject over time;
generate a best probable learning curve based on the historic learning curves of the graph, wherein the best probable learning curve is predictive of future learning by the primary CogBot for the subject;
obtain current learning data from the primary CogBot; and
generate information regarding a current status of the learning of the primary CogBot based on the best probable learning curve and the current learning data from the primary CogBot.

17. The system of claim 16, wherein generating the best probable learning curve comprises:
identifying an initial set of beeps in the graph, wherein each beep comprises a homogeneous dimension which is a locus of all intersecting points of the historic learning curves; and
selecting a subset of the initial set of beeps by imposing a global constraint, wherein the best probable learning curve is generated based on the subset of the initial set of beeps.

18. The system of claim 17, wherein the program instructions are further executable to:
update the best probable learning curve based on the current learning data to generated an updated best probable learning curve; and
repeat the obtaining the current learning data from the primary CogBot and the updating the best probable learning curve, iteratively, to generate a plurality of updated best probable learning curves over time.

19. The system of claim 18, wherein the program instructions are further executable to:
recalibrate the primary CogBot by generating a directed acyclic graph (DAG) based on the plurality of updated best probable learning curves over time, thereby producing a recalibrated primary CogBot; and
provide the recalibrated primary CogBot to one or more users via a network to answer inquiries regarding the subject.

20. The system of claim 16, wherein the best probable learning curve is generated utilizing Kalman filtering.
